(19) United States
(12) Patent Application Publication
(10) Pub. No.: US 2006/0265233 A1
(43) Pub. Date: Nov. 23, 2006

(54) Systems and methods for facilitating stock product returns

(75) Inventor: Steve Mundy, El Dorado Hills, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 11/134,104

(22) Filed: May 20, 2005

(51) Int. Cl. G06Q 99/00; G06F 15/02; G06F 9/46

(52) U.S. Cl. 705/1; 705/9

(57) ABSTRACT

Systems and methods are disclosed for providing enhanced visibility to all parties involved in the process of stock product return, accurate and convenient product data capture, timely shipment of return product, and effective quality controls over the entire product return process. Specifically, advanced notifications and product data are automatically sent to product suppliers for updating supplier internal systems such as inventory management systems, accounting management systems, etc. Pre-received product data is also to be employed for validating received return products in order to acquire effective quality control over merchandisers, carriers and any other involved parties.

### FIELD OF THE INVENTION

The invention generally relates to a merchandiser solution in the field of returns management, and more particularly, relates to systems and methods for facilitating stock product returns from retail stores, through merchandisers and carriers, to product suppliers.

### BACKGROUND OF THE INVENTION

Product returns have gained greater attention and respect as companies better understand the impact of returns management upon their business operations and customer relationships. In an effort to improve current returns management, certain solutions are required as more problems are identified in the field of product returns. One example involves returns of old stock product from retail stores, through merchandisers and carriers, to manufacturers or product suppliers. A merchandiser is a company that provides services to businesses that sell product through retail stores. Typically, merchandiser services include verifying placement of the product, auditing stock levels, adding new product, and removing old product. FIG. 1A illustrates a merchandiser's role in the process of returning old stock product. As shown in FIG. 1A, the return process starts with a merchandiser 2 collecting old stock product from a retail store 1. In current practice, the merchandiser 2 typically sends an agent to the retail store 1 and the agent records on a paper control log the product information (e.g., SKU number, quantity) of each item to be returned. Then the merchandiser's agent leaves from the retail location with all removed items, eventually packs the returned products in a box, and drops off the box of returned products to a carrier 3 such as UPS for shipment to the manufacturer or product supplier 4.

Quite a few issues may arise from the above-described mostly manual return process. For instance, the hand recording of product information, especially SKUs, may not be eligible and thus is error prone. Additionally, because sometimes the control log is lost or not inserted into the box containing returned products, after the box is received the supplier does not have any record to verify return products, thereby causing inaccuracy to inventory management.

Another issue is that the product supplier has almost no effective control over the merchandiser's practice. If the merchandiser holds returned products for extended periods of time before sending the products to the carrier for shipment, it will increase the likelihood of damaged or lost products. Meanwhile, the supplier has to keep excessive inventory to match that time extension in product returns, which certainly increases warehousing costs. Furthermore, the above return process allows the merchandiser instead of the supplier to select carriers, shipment dates, delivery service levels and all other shipping options. Without any effective control over the merchandiser's shipping practices, the supplier is unable to identify any merchandiser fraud or abuse in shipment arrangement. Nor is the supplier able to negotiate for special carrier rates by leveraging its shipment volume resulting from large amounts of products returned from various locations.

Throughout the current process, the product supplier has no visibility of the returned products. Until the returned products are received and all of the associated bills are finalized, the supplier will not know how many products are coming back to the warehouse, when these products will be received, or how much shipment cost it will be. Such receiving delays and reconciliation errors may significantly increase the supplier's operating costs. Therefore, there is a need for an improved method and system to overcome the above-stated problems and facilitate return management, particularly in the process of returning stock products.

### BRIEF SUMMARY OF THE INVENTION

The present invention seeks to enhance visibility to all parties involved in the process of stock product return by providing accurate and convenient product data capture, timely shipment of return product, and effective quality controls over the entire product return process. To that end, advanced notifications and product data can be automatically sent to product suppliers for updating supplier internal systems such as inventory management systems, accounting management systems, etc. Pre-received product data can also be employed to validate received return products for purposes of quality control over merchandisers, carriers and any other involved parties.

According to one embodiment of the invention, a method for facilitating return of stock product comprises the steps of: (A) using a portable electronic device to capture product data from a return product, said portal electronic device comprising at least a memory portion for storing said product data; (B) processing said product data in said portable electronic device to generate return shipping label data associated with said return product; (C) transferring said return shipping label data from said portable device to a carrier computer, said carrier computer configured to communicate with said portable electronic device over a communications network; (D) based upon said return shipping label data, generating an electronic return shipping label in said carrier computer; (E) transferring said electronic return shipping label from said carrier computer for storage in said memory portion of said portable electronic device; (F) printing a hardcopy of said electronic return shipping label at a local printer, said local printer configured to receive said electronic return shipping label from said portable electronic device; and (G) enclosing said return product into a container and affixing said hardcopy of said electronic return shipping label to said container for shipment.

According to another embodiment of the present invention, a system for facilitating returns of stock product comprises: a portable electronic device comprising a processor and a memory portion accessible to said processor, said portable electronic device configured for: capturing product data from a return product to store in said memory portion; generating a request for a return shipping label based in part upon said product data; communicating said request to a first computer over a communications network, said first computer configured to produce an electronic return shipping label based in part upon said request; and receiving said electronic return shipping label from said first computer.

In a preferred embodiment, the system further comprises a portable printer in communication with said portable electronic device, said portable printer configured to receive and print a hardcopy of said electronic return shipping label. In another preferred embodiment, the portable electronic device of the system is further configured for communicating said product data to a second computer, said second computer configured to, in response to receiving said product data, update one or more computer databases based upon said product data.

Another embodiment of the present invention is a portable electronic device. The portable electronic device is comprised of: a processor; a memory portion accessible to said processor; a network interface in communication with said processor, said network interface configured to facilitate communication between said processor and a first server computer over a communications network; and a user interface in communication with said processor, said user interface configured to receive product data from a return product for storage in said memory portion, wherein, said processor is configured for: processing said product data to generate return shipping label data associated with said return product; transferring said return shipping label data, via said network interface, to said first server computer, said first server computer configured to generate an electronic return shipping label based in part upon said return shipping label data; receiving said electronic return shipping label from said first server computer; and directing said electronic return shipping label to a printer for printing a hard copy of said electronic return shipping label, said printer in communication with said processor through said network interface.

Yet another embodiment of the present invention provides a method for providing visibility in a process of returning stock product. This method comprises the steps of: (A) capturing product data from a return product, said product data captured by a portable electronic device, said portal electronic device comprising at least a memory portion for storing said product data; (B) transferring said product data from said portable electronic device to a supplier computer, said supplier computer configured to communicate with said portable electronic device over a communications network, and further configured to update one or more supplier databases using said product data; (C) sending a shipment request from said portable electronic device to a carrier computer for generating a return shipping label for shipping said return product, said carrier computer configured to communicate with said portable electronic device over said communications network; (D) generating an electronic return shipping label in said carrier computer, and transferring said electronic return shipping label from said carrier computer for storage in said memory portion of said portable electronic device, said electronic return shipping label including at least a tracking identifier; (E) transferring said tracking identifier in said electronic return shipping label to said supplier computer from either said carrier computer or said portable electronic device; (F) printing a hardcopy of said electronic return shipping label at a local printer, said local printer configured to communicate said portable electronic; (G) enclosing said return product into a container and affixing said hardcopy of said electronic return shipping label to said container for shipment; (H) using said tracking identifier to view movement of said container during shipment; and (J) when said return product is received, validating said return product against said return product data stored in said supplier computer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A-B illustrate differences between a previously employed product return process and an improved process under the present invention;

FIG. 2 is a high-level block diagram of a system for facilitating product return according to one embodiment of the present invention;

FIG. 3 is a process flow diagram illustrating the product return steps in the system of FIG. 2 according to one embodiment of the present invention;

FIG. 4 illustrates exemplary hardware requirements for implementing the system of FIG. 2 according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

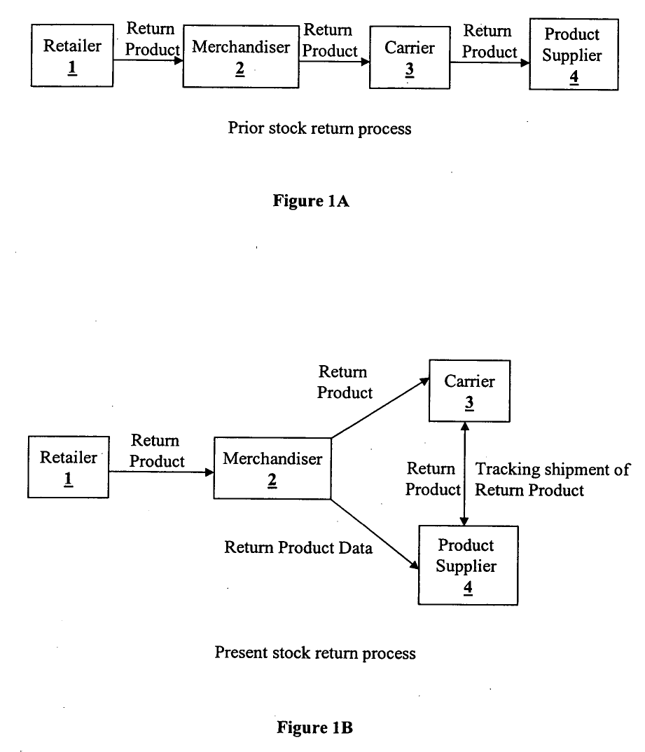

Referring to FIG. 1B, an improved process for returning stock product under the present invention will be described. In FIG. 1B, the improved process allows the supplier 4 to obtain return product data from the merchandiser 2 before the return products are actually received from the carrier 3. As will be described in detail below, such data acquisition can be realized by the merchandiser 2 using a portable data capture device to capture product information electronically while inserting the removed items into a container at the retailer store 1. Then the product data stored in the portable device can be sent to the supplier 4 even prior to the merchandiser 2 physically transfers the returned products to the carrier 3. In addition, this portable device is pre-configured with certain applications that allow the merchandiser 2 to communicate with a designated carrier, here shown as carrier 3, to request for shipping the return products, particularly for obtaining printable electronic return shipping labels. As a result, the return products enclosed in a container with shipping labels affixed thereto can be ready for shipment before the merchandiser 2 leaves from the retail store 1. Once the carrier 3 receives the returned products, the supplier 4 may be provided with shipping information including a tracking identifier (e.g., 1Z tracking numbers used by UPS) to keep tracking movement of the return products in shipment.

In the process of FIG. 1B, by receiving advanced notifications of what is coming back in stock, the supplier 4 can always maintain sufficient inventory while keeping warehousing costs reasonably low. The supplier 4 can also use the product data pre-received from the merchandiser 2 for validating what is actually received from the carrier 3 to achieve effective quality control over shipping practices. As a matter of fact, the improved process provides the supplier 4 with complete visibility of the movement of returned products, starting from when the returned products are removed by the merchandiser 2 from the retail store 1, to the point of the products' being shipped by the carrier 3, and till when the products are delivered to the supplier 4.

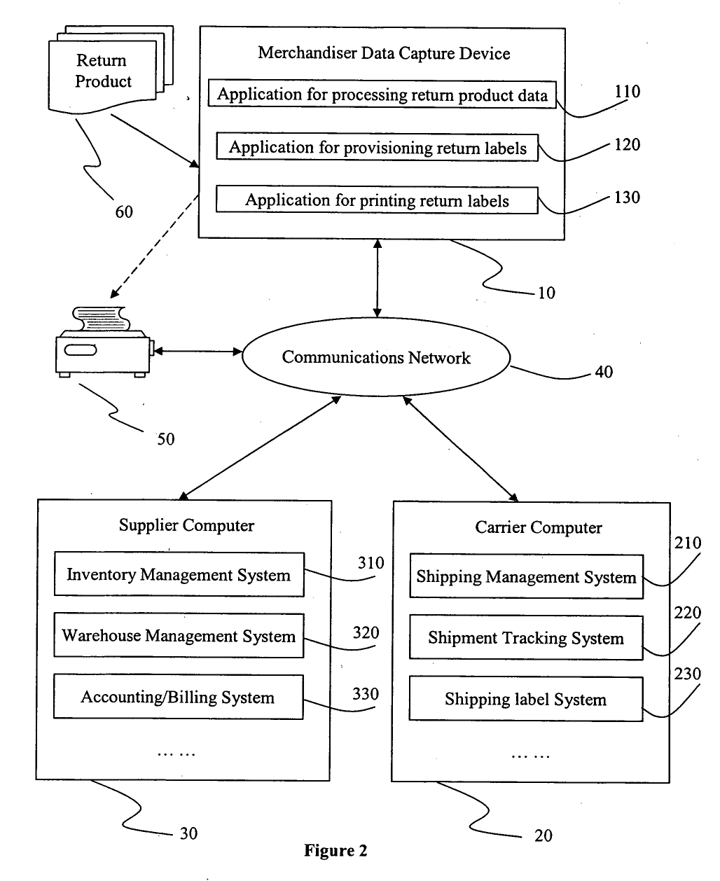

The improved process and method for returning stock product, as outlined in FIG. 1B, can be implemented through a system for facilitating stock product returns. A high-level block diagram of this system is presented in FIG. 2. The system is comprised of a portable data capture device 10 used by the merchandiser 2, a carrier computer 20 operated by the carrier 3 and a supplier computer 30 operated by the supplier 4. In a preferred embodiment, all these devices or computers are capable of transmitting and receiving data over a communications network 40, wired or wireless, using communication means including, but not limited to, standard Internet Protocols such as HTTP and HTTPS. Besides EDI (Electronic Data Transfer), the communication between the merchandiser 2, carrier 3 and supplier 4 can also be accomplished by electronic mails or electronic displays for viewing data. Moreover, even if any of the entities, i.e., the merchandiser 2, carrier 3 and supplier 4, are not connected to the communications network 40, the communication can be made through phones, fax machines or emails. As seen in FIG. 2, the system further comprises a printer 50 for the merchandiser 2 to print return shipping labels in the retailer store 1. In a preferred embodiment, the printer 50 is portable and capable of communicating with the data capture device 10 via the communications network 40. The printer 50 can also be connected to the data capture device 10 through the Bluetooth technology that is well known in the art.

In a preferred embodiment, the portable data capture device 10 is a PDA (personal digital assistant) device, which can be a hand-held computer or a palm-sized computer. As will be described in detail below, regardless of its type, such PDA device is typically comprised of a small microprocessor, an operating system containing pre-programmed instructions for the microprocessor, a solid-state memory including static RAM and/or Flash memory, some type of LCD display screen, batteries for providing power, and input device that typically comprises a miniature keyboard in combination with a touch screen for hand-held computers, or a stylus and touch screen in combination with or a handwriting recognition program. As is well known in the art, any PDA must be able to communicate with a PC and the communication between PDA and PC is referred to as data synchronization or syncing. This is typically done through a serial or USB port on the PDA. Some PDAs have a cradle that they sit in while hooked up to the PC. To synchronize to or from your PDA, synchronization utility (HotSync for Palm OS, ActiveSync for PocketPC) is required to be installed on the computer's hard drive to connect the PDA to your PC (cable, IR, wireless, modem). As shown in FIG. 2, the data capture device 10 comprises certain applications including an application for processing return product data 110, an application for provisioning return shipping labels 120, and an application for printing return shipping labels 130. With the data capture device 10, the merchandiser 2 is able to capture product data of the return product 60 using key entry, bar code scanning, electronic signature capture, and electronic data transfer. Such product data (e.g., SKUs) is received and stored in the data capture device 10 through the application for processing return product data 110. In a preferred embodiment, the application 120 is configured to for the merchandiser 2 to send a request to the carrier 3 for generating return shipping labels and receiving generated electronic shipping labels. The request for and receipt of shipping labels can be accomplished through email exchange over the communications network 40. After receiving the electronic shipping labels into the data capture device 10, the application for printing return shipping labels 130 is configured to direct the labels for printing by communicating with the printer 50.

For illustration purposes, only one carrier computer is shown in FIG. 2. But it is to be understood that the carrier computer 20 refers to one or more server computers residing in a variety of carrier systems that communicate with either the data capture device 10 or the supplier computer 30 via the communications network 40 in the stock product return process. The exemplary carrier systems shown in FIG. 2 include a shipping management system 210, shipment tracking system 220, and a shipping label system 230. Similarly, the supplier computer 30 refers to one or more server computers residing in a variety of supplier systems, such as an inventory management system 310, a warehouse management system 320, and an accounting/billing system 330. As will be described in detail below, the supplier 4 can use product data to update those supplier systems in a timely manner even prior to receiving the return product 60.

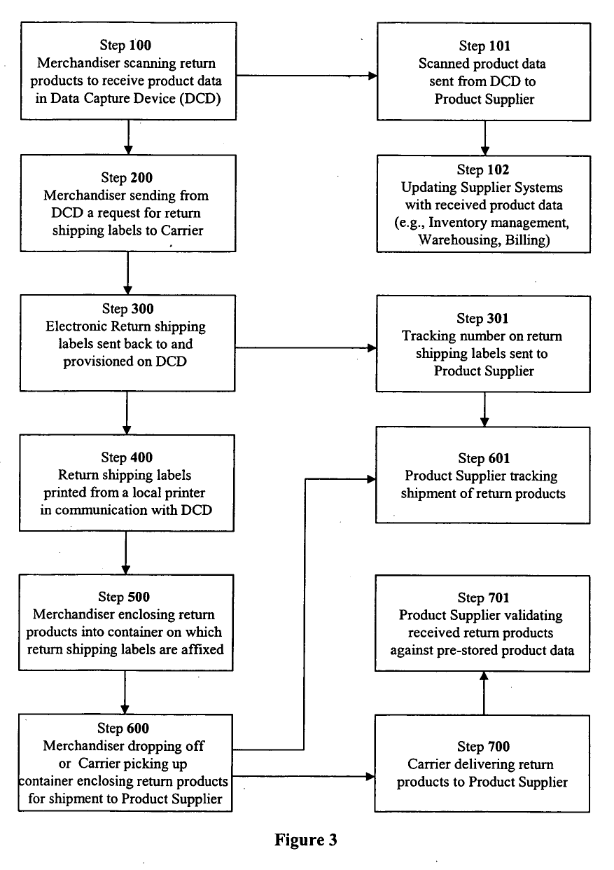

FIG. 3 illustrates a step-by-step process for returning stock product in the above-described system in FIG. 2. The process starts with Step 100, when the merchandiser 2 uses the data capture device 10 to capture product data from each item to be returned in the retail store 1. The product data is stored in the data capture device 10 and later transferred from the device 10 to the supplier computer 30 as seen in step 101. In a preferred embodiment, the data capture device 10 is a PDA, which can be connected to a PC computer for data synchronization. The product data synchronized in the PC computer can be transferred to the supplier computer 30 through EDI over the communications network 40. Then based upon the received product data, the related supplier systems can be updated at Step 102. For example, the inventory management system 310 may be updated to reflect the incoming products and adjust the product backorder level accordingly. Similarly, in the warehouse management 320 the stock-in and stock-out schedules may be monitored or adjusted in anticipation of the return products. The accounting/billing system 330 can also be updated with asset increase or decrease as a result of the return product.

Turning back to the merchandiser's practice, Step 200 shows that after all returned items 60 are picked up and ready to be removed from the retail store 1, the merchandiser 2 can use the data capture device to send a request for the carrier computer 20 to generate return shipping labels. In a preferred embodiment, the request includes information on what type of products to be shipped, where the products are shipped from and shipped to, what shipment service to be used, etc. In practice, the data capture device 10 is preferably pre-programmed by the supplier 4 with instructions for automatic generation of the shipment request based in part upon data entry by the merchandiser 2. This shifts most of the control over shipping practices from the merchandiser 2 to the supplier 4 because the supplier 4 is able to select its preferred carrier and pre-program the data capture device 10 with carrier information in addition to needed supplier information, e.g., a ship-to warehouse address. Once the request is received, the carrier computer 20, which probably is the server computer of the shipping label system 230, will respond by sending back the requested return shipping labels in an electronic form at Step 300. The data capture device 10 is configured to receive the label information and provision the electronic return labels on display screen of the device. Each return shipping label is identified by a unique tracking number, such as the 1Z tracking number used by UPS. As is well known in the art, once a package is affixed with a shipping label identified by a tracking number, a shipping customer can use the tracking number to keep tracking the movement of the package. Therefore, in a preferred embodiment, the supplier 4 may be provided with tracking numbers associated with those return products when the shipping labels are produced. Then at Step 601, the supplier 4 can use the tracking numbers to track shipment of the products when the products are received by the carrier 3 and enter into the carrier's shipment network. Currently, a lot of shipping companies provide for their customers an online shipment tracking system, which typically allows the customer to enter the received tracking number on a webpage and then display the shipment status of the customer's packages.

At Step 400, the data capture device 10 communicates with the printer 50 for on-site printing the electronic return shipping labels. In operation, the printer 50 is preferably portable and the merchandiser 2 carries this portable printer 50, along with the data capture device 10, for collecting returned items from the retail store 1. At Step 500, the printed labels are affixed to one or more container for holding all returned items. At Step 600, the containers with products enclosed therein are either dropped off by the merchandiser 2, or picked up by the carrier 3 for shipment. The containers will then be scanned to create shipment records in carrier systems. During the shipment process, the containers may be scanned at each receiving facility of the carrier 3 and the shipment data will be updated accordingly to provide the supplier 4 with the most recent shipment status.

At Step 700, the supplier 4 received the returned products 60 from the carrier 3. Then Step 701 shows that the supplier 4 can validate the received products against the pre-stored product data. From the validation step, the supplier 4 is able to know whether all expected products are actually received, how many are damaged in shipment, how many are never shipped, etc. Based upon that knowledge, the supplier 4 can identify any weakness that needs to be improved in the product return process, evaluate performances of the merchandiser 2 and the carrier 3, and gain effective cost controls.

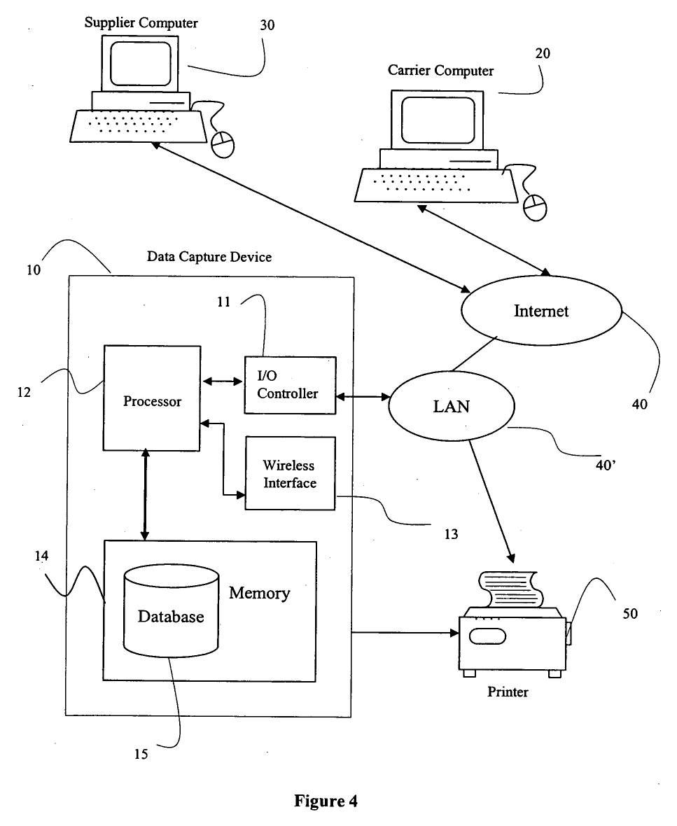

In FIG. 4, hardware requirements for implementing the above-described system for stock product return are exemplified. As shown in FIG. 4, the data capture device 10 is comprised of an Input/Output controller 11, a processor 12, a wireless interface 13, and a memory 14 that stores one or more databases 15. In one embodiment, the data capture device 10 is a PDA, and as a result, compared with those processors used in the big desktop and laptop PCs, the processor 12 is typically a smaller and cheaper microprocessor such as the Motorola Dragonball, Multiprocessor without Interlocked Pipeline Stages (MIPS), or Hitachi's SH7709a. The processor 12 uses a data bus to convey data and program instructions to and from the memory 14. The processor 12 also communicates with various peripherals or external devices through an I/O data bus. The memory 14 includes two kinds of memory, namely a Random Access Memory (RAM) and programmable permanent memory. Generally, software applications are loaded, executed, and run in RAM. RAM is also used to receive data input by the user, as well as to display the application output or results to the user. For portable electronic devices, the programmable permanent memory is typically a FLASH memory. Typically, the I/O controller 11 is used for the processor 12 to communicate with external communication networks through a variety of interfaces such as data communication oriented protocols including X.25, ISDN, DSL, cable modems, etc. The I/O controller 11 may also incorporate a modem (not shown) for interfacing and communicating with a standard telephone line. Alternatively, the communications I/O controller 11 may incorporate an Ethernet interface for communicating over a LAN. Any of these interfaces may be used to access the Internet 40, intranets, LANs 40′, or other data communication facilities. The wireless interface 13 that is operatively connected to an antenna for the processor 12 to communicate wirelessly with other devices such as printer 50. The wireless communication can be accomplished through various protocols, such as the IEEE 802.11 protocols, 802.15.4 protocol, or a standard 3G wireless telecommunications protocols, such as CDMA2000 1×EV-DO, GPRS, W-CDMA, or other protocols.

The various application software as described above, which comprises an ordered listing of application steps, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed is:

1. A method for facilitating returns of stock return products, said method comprising the steps of:
(A) using a portable electronic device to capture product data from one of said return products, said portal electronic device comprising at least a memory portion for storing said product data;
(B) processing said product data in said portable electronic device to generate return shipping label data associated with said return product;
(C) transferring said return shipping label data from said portable device to a carrier computer, said carrier computer configured to communicate with said portable electronic device over a communications network;
(D) based upon said return shipping label data, generating an electronic return shipping label in said carrier computer;
(E) transferring said electronic return shipping label from said carrier computer to said portable electronic device for storage in said memory portion of said portable electronic device;
(F) printing a hardcopy of said electronic return shipping label at a printer, said printer configured to receive said electronic return shipping label from said portable electronic device; and
(G) enclosing said return product into a container and affixing said hardcopy of said electronic return shipping label to said container for shipment.

2. The method of claim 1, comprising further steps of sending said product data of said return product to a supplier computer and updating one or more supplier systems based upon said product data.

3. The method of claim 1, comprising further steps of:
sending said product data of said return product to a supplier and storing said product data in a supplier computer; and
validating said return product against said return product data once said supplier receives said return product.

4. The method of claim 1, wherein said printer is located proximately to said portable electronic device.

5. The method of claim 1, wherein said product data comprises at least a SKU number identifying said return product.

6. The method of claim 1, wherein said return shipping label data comprises at least origin data, destination data, and shipment service level data.

7. The method of claim 1, wherein said electronic return shipping label contains a unique tracking identifier.

8. The method of claim 7, comprising a further step of communicating said unique tracking identifier to a supplier for tracking status of said return product in shipment.

9. A system for facilitating returns of stock product, said system comprising:
a portable electronic device comprising a processor and a memory portion accessible to said processor, said portable electronic device configured for:
capturing product data from a return product to store in said memory portion;
generating a request for a return shipping label based in part upon said product data;
communicating said request to a first computer over a communications network, said first computer configured to produce an electronic return shipping label based in part upon said request; and
receiving said electronic return shipping label from said first computer.

10. The system of claim 9, further comprising a portable printer in communication with said portable electronic device, said portable printer configured to receive and print a hardcopy of said electronic return shipping label.

11. The system of claim 9, wherein said portable electronic device is further configured for receiving key entry data.

12. The system of claim 9, wherein said portable electronic device further comprises an output interface for displaying said electronic return shipping label.

13. The system of claim 9, wherein said portable electronic device is further configured for communicating said product data to a second computer, said second computer configured to, in response to receiving said product data, update one or more computer databases based upon said product data.

14. The system of claim 9, wherein said request comprises at least a shipping origin, a shipping destination and shipment service level.

15. A portable electronic device comprising:
a processor;
a memory portion accessible to said processor;
a network interface in communication with said processor, said network interface configured to facilitate communication between said processor and a first server computer over a communications network; and
a user interface in communication with said processor, said user interface configured to receive product data from a return product for storage in said memory portion,
wherein, said processor is configured for:
processing said product data to generate return shipping label data associated with said return product;
transferring said return shipping label data, via said network interface, to said first server computer, said first server computer configured to generate an electronic return shipping label based in part upon said return shipping label data;
receiving said electronic return shipping label from said first server computer; and
directing said electronic return shipping label to a printer for printing a hard copy of said electronic return shipping label, said printer in communication with said processor through said network interface.

16. The portable electronic device of claim 15, wherein said processor is further configured for communicating with a second server computer via said network interface over said communications network, said second server computer configured to receive said product data from said processor.

17. The portable electronic device of claim 16, wherein said processor is further configured to transfer said electronic return shipping label to said second server computer.

18. The portable electronic device of claim 15, further comprising a display device for displaying said electronic return shipping label.

19. The portable electronic device of claim 15, wherein said printer is configured to communicate with said processor via Bluetooth technology.

20. The portable electronic device of claim 15, wherein said return shipping label data comprises at least a shipping origin, a shipping destination, and a shipment service level.

21. A method for providing visibility in a process of returning stock product, said method comprising the steps of:
(A) capturing product data from a return product, said product data captured by a portable electronic device, said portable electronic device comprising at least a memory portion for storing said product data;
(B) transferring said product data from said portable electronic device to a supplier computer, said supplier computer configured to communicate with said portable electronic device over a communications network, and further configured to update one or more supplier databases using said product data;
(C) sending a shipment request from said portable electronic device to a carrier computer for generating a return shipping label for shipping said return product, said carrier computer configured to communicate with said portable electronic device over said communications network;
(D) generating an electronic return shipping label in said carrier computer, and transferring said electronic return shipping label from said carrier computer for storage in said memory portion of said portable electronic device, said electronic return shipping label including at least a tracking identifier;
(E) transferring said tracking identifier in said electronic return shipping label to said supplier computer from either said carrier computer or said portable electronic device;
(F) printing a hardcopy of said electronic return shipping label at a printer, said printer configured to communicate said portable electronic device;
(G) enclosing said return product into a container and affixing said hardcopy of said electronic return shipping label to said container for shipment;
(H) using said tracking identifier to view movement of said container during shipment; and
(J) when said return product is received, validating said return product against said return product data stored in said supplier computer.
